(19) United States
(12) Patent Application Publication
(10) Pub. No.: US 2013/0290939 A1
(43) Pub. Date: Oct. 31, 2013

(54) DYNAMIC DATA FOR PRODUCING A SCRIPT

(71) Applicants: OFER ELIASSAF, Modiin (IL); Meidan Zemer, Hod-Hasharon (IL); Yair Horovitz, Mazkeret Batya (IL)

(72) Inventors: OFER ELIASSAF, Modiin (IL); Meidan Zemer, Hod-Hasharon (IL); Yair Horovitz, Mazkeret Batya (IL)

(21) Appl. No.: 13/459,356

(22) Filed: Apr. 30, 2012

(51) Int. Cl. G06F 9/44

(52) U.S. Cl. 717/135

(57) ABSTRACT

Dynamic data associated with multiple execution instances of an application process is stored in a data structure. The dynamic data includes correlation data for identifying a communication between at least one client computer and a server computer. The dynamic data in the data structure is retrievable to produce a script to simulate behavior relating to execution of the application process.

### BACKGROUND

Application processes can be run on server computers, for access by client computers. Examples of application processes include processes associated with web applications or other applications. To perform testing of an application process, a script can be created for simulating a behavior of the application process.

### BRIEF DESCRIPTION OF THE DRAWINGS

Some embodiments are described with respect to the following figures:

FIG. 1 is a block diagram of an example arrangement that incorporates some implementations;

FIGS. 2 and 3 are flow diagrams of processes according to some implementations; and

FIG. 4 is a block diagram of an example computing system that incorporates some implementations.

### DETAILED DESCRIPTION

A script can include machine-readable instructions and variables, and can be generated based on recording behavior of an application process. The script can be replayed to simulate the behavior associated with execution of the application process. In some examples, an application process can be executed on a server computer. The application process can be a web application process or other type of business process that is accessible by users (and corresponding client computers).

In some implementations, a script can be a transport script, which is used for simulating traffic behavior associated with execution of an application process. Traffic associated with execution of an application process can include dynamic data, which can refer to data that changes with different executions of the application process. To produce a script, traffic associated with the application process during execution can be monitored and analyzed to identify the dynamic data. The dynamic data can then be used for generating a script, such as a transport script, which can be replayed to perform a target task. Replaying of a transport script allows for the traffic behavior associated with execution of the application process to be simulated, including dynamic data behavior.

Examples of tasks that can be performed based on replaying a script include a testing task, such as testing load at a server computer or load of an application process, testing of an application programming interface (API), or some other type of testing. Other tasks can include synthetic user monitoring, which simulates user behavior to allow a determination of performance of a website or application process (e.g. application process is running slowly, downtime is experienced, or some other fault or error is present).

In some examples, dynamic data associated with execution of an application process can be determined based on just a single execution instance of the application process. An “execution instance” of an application process can refer to an instance of the application process as invoked by a requestor. However, producing a script based on dynamic data of a single execution instance of the application process can result in a script that may not accurately simulate dynamic data behavior associated with execution of the application process. Also, depending on the type of analysis used, identification of certain types of dynamic data can be time-consuming. As a result, to produce a script in a timely manner, less optimal analysis techniques may be employed for identifying certain types of dynamic data, which can result in a less accurate script.

In accordance with some implementations, to provide a more robust script, traffic associated with multiple execution instances of an application process can be monitored and analyzed for the purpose of identifying dynamic data for use in producing the script. In some cases, a relatively large number (e.g. 100 or more) of execution instances of the application process can be monitored. Moreover, instances of multiple application processes can also be monitored. Based on the monitored traffic associated with execution instances of one or multiple application processes, dynamic data associated with each application process can be identified, and such identified dynamic data can be used for purposes of producing a script (or multiple scripts), such as transport script(s).

In addition, to address issues that are associated with having to trade off accuracy in identifying dynamic data versus time for performing such analysis, the analysis of traffic for identifying dynamic data can be performed “offline” from the traffic recording (or monitoring) process. In performing the analysis of recorded traffic in an offline manner, techniques or mechanisms according to some implementations can select more accurate techniques for the purpose of identifying certain types of dynamic data.

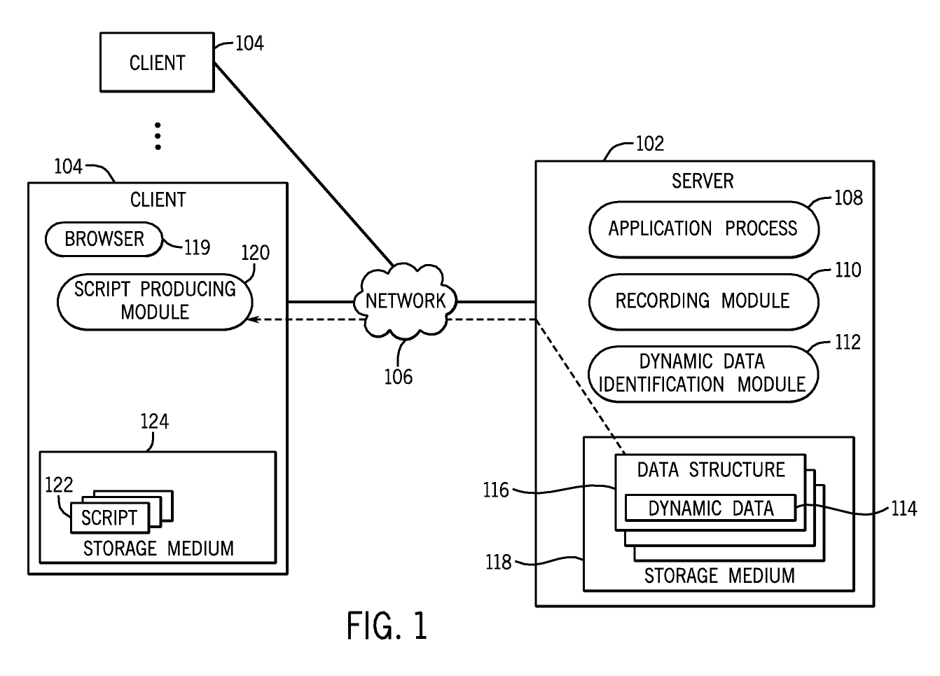

FIG. 1 is a block diagram of an example arrangement that includes a server computer 102 and client computers 104 that are coupled to the server computer 102 over a network 106. A user at a client computer 104 can access (such as by use of a browser 119) an application process 108 that is executable on the server computer 102. The application process 108 can be a web application process or some other type of business process. Although just one application process 108 is shown in FIG. 1, it is noted that in alternative implementations, multiple application processes can be executable on the server computer 102. As further examples, there can be multiple servers 102 having respective application processes.

The server computer 102 can also include a recording module 110 that is able to monitor (record) traffic associated with execution instances of the application process 108. An execution instance of the application process 108 can refer to an instance of the application process 108 as invoked by a client computer 104, such as by the browser 119 in the client computer 104.

Although the recording module 110 is shown as being part of the server computer 102, note that the recording module 110 can alternatively be located at a separate machine coupled to the network 106 that is able to sniff the traffic associated with the application process 108, such as traffic exchanged between the application process 108 and one or multiple client computers 104.

The recording module 110 can record traffic associated with execution instances of one application process 108, or can record execution instances of multiple application processes.

In some implementations, the server computer 102 can also include a dynamic data identification module 112 that is able to analyze the recorded traffic (as recorded by the recording module 110) for identifying dynamic data in the traffic. In examples according to FIG. 1, the dynamic data identification module 112 can identify dynamic data 114, which is then stored in a data structure 116. The identified dynamic data 114 can be dynamic data associated with multiple execution instances of a particular application process. In examples according to FIG. 1, multiple data structures 116 can be provided for storing dynamic data of respective application processes.

The data structure(s) 116 can be stored in a storage medium (or storage media) 118. The data structure(s) 116 can be accessed at a later time by a client computer 104 or by some other entity.

Although FIG. 1 shows the recording module 110 and dynamic data identification module 112 being at the server computer 102, it is noted that in other implementations, the recording module 110 and/or dynamic data identification module 112 can be located at a client computer 104 or in another node between the client computer 104 and server computer 102.

The client computer 104 includes a script producing module 120, which is able to query a data structure 116 containing dynamic data 114 associated with a respective application process 108. The script producing module 120 is able to retrieve the dynamic data 114 from the data structure 116, and the script producing module 120 is able to produce a script 122 based on the dynamic data 114. Multiple scripts 122 (for multiple respective application processes) can be stored in a storage medium (or storage media) 124 in the client computer 104. Although the script producing module 120 is shown as being part of the client computer 104, it is noted that in alternative examples, the script producing module 120 can be located on a different machine.

A script 122 can be later replayed for the purpose of simulating behavior associated with execution of the application process 108. In examples where the script 122 is a transport script, the replaying of the transport script simulates traffic behavior, including dynamic data traffic behavior, associated with traffic exchange between a client computer 104 (or multiple client computers 104) and the application process 108 during execution of the application process 108.

Various types of dynamic data can be identified by the dynamic data identification module 112. A first type of dynamic data includes “correlation data,” which refers to data that is generated by the server computer 102 and communicated to a client computer 104 during interaction between the client computer 104 and the application process 108 in the server computer 102. This server-generated data that is provided to the client computer 104 can be data that is useable by the server computer 102 to associate a particular communication with a given instance of the application process 108. As an example, correlation data can include a session identifier, for identifying a particular session between a client computer 104 and the application process 108 in the server computer 102. In other examples, other identifiers relating to communication flows can be used. As yet further examples, correlation data can include authentication data that is produced by the server computer 102 and communicated to the client computer 104 to allow the client computer 104 to use the authentication data for subsequent communications with the application process 108.

Another type of dynamic data includes parameter data, which refers to user-entered data at the client computer 104 (such as at the browser 119). As examples, user-entered data can include search terms entered into a query box of a search engine. For example, the application process 108 is a search application that is accessible from the client computer 104 to search for information. As other examples, user-entered data can include data entered into a form, such as during a registration process or other processes. The user-entered data is communicated from the client computer 104 to the server computer 102.

Parameter data can thus be discovered by identifying data originated at a client computer 104, where values of the data change between different execution instances of the same application process 108. In some examples, a dictionary can be built, where the dictionary can include parameters and corresponding different values. The dictionary can be later accessed when building a script.

Another type of dynamic data includes asynchronous data. In some implementations, the application process 108 can asynchronously provide data that is continually changing to a client computer 104. As an example, the application process 108 can be continually providing updated stock prices or sports scores to the client computer 104. Recording of asynchronous data can be sensitive to the manner in which traffic of the application process 108 was recorded by the recording module 110. For example, the speed of execution of the application process 108 relative to the speed of recording by the recording module 110 may be relevant. Also, the status (e.g. excessive loading, light loading, etc.) of the server computer 102 may also impact recording of asynchronous data.

Another type of dynamic data includes client-generated data. The client-generated data is contrasted to user-entered parameter data, which is data entered by a user. Client-generated data can refer to data that is generated by an automated module in the client computer 104. For example, the automated module may be an encryption module, a hashing module, or other type of module that is able to apply some type of transformation on input data, such as user-entered data.

The identification of dynamic data by the dynamic data identification module 112 can use various techniques. To identify correlation data, one or some combination of the following techniques can be employed. The identification of correlation data can be based on correlation rules, which can include a set of patterns. Data matching the patterns in the set can be identified as correlation data.

In further examples, the identification of correlation data can use a response-based correlation technique. The response-based correlation technique looks for information that first arrived from the server computer 102 and later was returned to the server computer 102 by a client computer 104.

In alternative examples, correlation data can be identified by using a replay-and-scan technique, where an execution instance of an application process is recorded once, and the corresponding generated script is produced and replayed. When the replay of the script fails, the replay-and-scan technique attempts to look for correlation data by comparing the recorded data to the replayed data until a failure point is identified. The foregoing process is performed iteratively until the replay of the script passes with no errors, such that all correlation data is found.

The foregoing example techniques of identifying correlation data have varying degrees of effectiveness. Also, some of the techniques can be more time consuming than other techniques. In accordance with some implementations, the dynamic data identification module 112 can selectively use any one or some combination of the foregoing example techniques for identifying correlation data. For example, if greater accuracy is desired, then the dynamic data identification module 112 can select the technique(s) that provides better accuracy. On other hand, if greater speed of execution is desired, then the dynamic data identification module 112 can select the technique(s) with greater execution speed. The goals of better accuracy or greater speed of execution can be user-specified, or can be preconfigured at the dynamic data identification module 112.

Note that the analysis of recorded data for the purpose of identifying dynamic data can be performed offline with respect to the monitoring (recording) of the data by the recording module 110. By performing the data analysis in an offline manner, greater flexibility can be afforded in the selective use of various different techniques for identifying dynamic data.

To identify asynchronous data, one or some combination of the following techniques can be used. A first type technique for identifying asynchronous data is a rule-based technique, where predefined patterns can be defined and matched to recorded data for the purpose of identifying asynchronous data. Another example technique is a classification-based technique. The classification-based technique measures the time and content of network traffic that was generated by a client computer 104 and the server computer 102 during recording of an execution instance of the application process 108. The measured time and content can then be classified to identify asynchronous data.

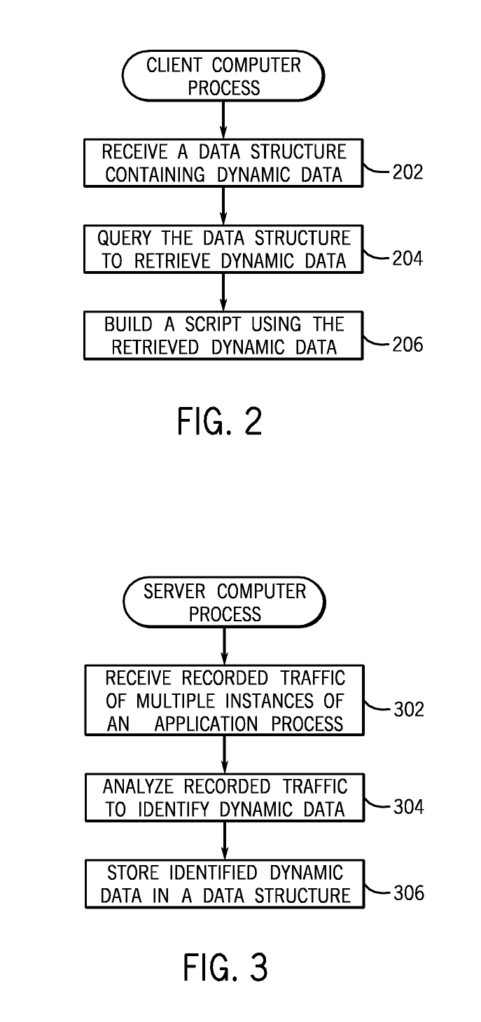

FIG. 2 is a flow diagram of a process according to some implementations. The process can be performed at the client computer 104 (such as by the script producing module 120), for example. The client computer 104 can receive (at 202) a data structure (e.g. 116 in FIG. 1) containing dynamic data of multiple execution instances of an application process (e.g. 108 in FIG. 1). The client computer 104 can then query (at 204) the data structure 116 to retrieve the dynamic data of the multiple instances of the application process for producing a script (e.g. 122) that simulates behavior relating to execution of the application process.

The script producing module 120 can build (at 206) the script 122 (FIG. 1) by including the dynamic data in the script 122. For example, the script 122 can include various variables that represent different types of dynamic data. For example, a variable can store parameter data, another variable can store correlation data, and so forth. Values stored in the variables can be used when the script is being replayed. The script 122 can also include instructions to perform tasks with respect to the application process.

In an example where an execution instance of the application process 108 involves web browsing by a client computer 104 to a particular web URL (uniform resource locator), the produced script 122 can include instructions for simulating browsing of the web URL, and variables in the script 122 can be used to provide the respective dynamic data for simulating the browsing behavior.

FIG. 3 is a flow diagram of a process performed at the server computer 102 (such as by the dynamic data identification module 112), for example. The server computer 102 receives (at 302) recorded traffic of multiple execution instances of an application process. The recording of the traffic can be performed by the recording module 110 of the FIG. 1, which can execute in the server computer 102 or can execute on a machine that is separate from the server computer 102. The process of FIG. 3 then analyzes (at 304) the recorded traffic to identify dynamic data. The analysis can employ any number of techniques, such as those discussed above, for identifying the dynamic data.

The process of FIG. 3 then stores (at 306) the identified dynamic data into a data structure, such as a data structure 116 in FIG. 1. The data structure can be stored in a storage medium for later access, such as by a client computer 104.

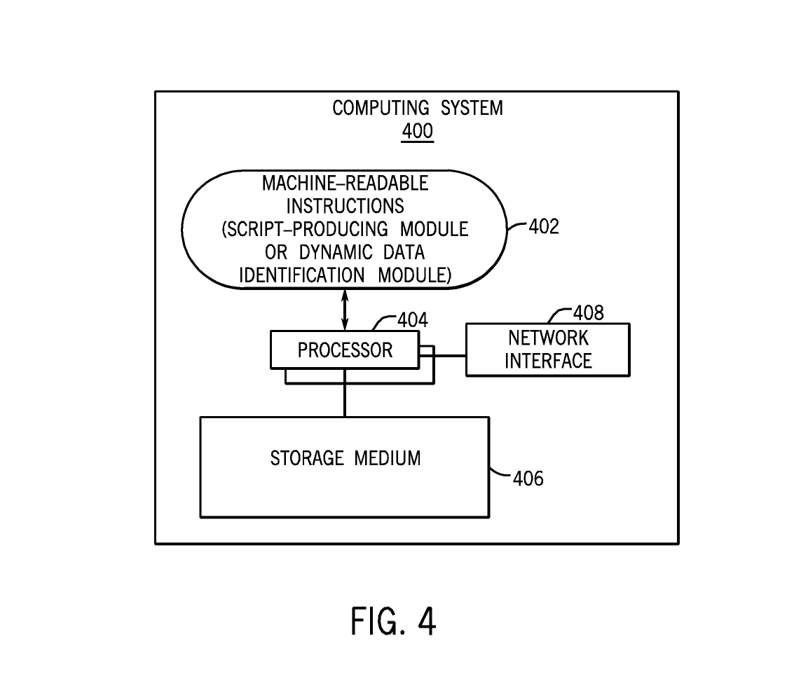

FIG. 4 is a block diagram of an example computing system 400, which can be either the server computer 102 or client computer 104 of FIG. 1. The computing system 400 includes machine-readable instructions 402, which can include the dynamic data identification module 112, script producing module 120, or any other module depicted in FIG. 1. The machine-readable instructions 402 are executable on one or multiple processors 404. A processor can include a microprocessor, microcontroller, processor module or subsystem, programmable integrated circuit, programmable gate array, or another control or computing device.

The processor(s) 404 can be connected to a network interface 408 (to allow the computing system 400 to communicate over a network). The processor(s) 404 can also be connected to a storage medium (or storage media) 406.

The storage medium (or storage media) 406 can be implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, by a system having a processor, a data structure containing dynamic data of a plurality of execution instances of an application process, where the dynamic data includes correlation data for identifying a communication between at least one client computer and a server computer; and
querying, by the system, the data structure to retrieve the dynamic data of the plurality of execution instances of the application process for producing a script that simulates behavior relating to execution of the application process.

2. The method of claim 1, wherein receiving the data structure containing the dynamic data comprises receiving the data structure that further contains asynchronous data of the plurality of execution instances of the application process.

3. The method of claim 1, wherein receiving the data structure containing the dynamic data comprises receiving the data structure that further contains data generated by the at least one client computer and sent to the server computer.

4. The method of claim 3, wherein the generated data includes data transformed from user-input data.

5. The method of claim 1, wherein receiving the data structure containing the dynamic data comprises receiving the data structure that further contains user-entered parameter data.

6. The method of claim 5, further comprising:
identifying values of the parameter data that change among the execution instances of the application process; and
building a dictionary of the values of the parameter.

7. The method of claim 1, wherein the dynamic data in the data structure is identified based on recorded data monitored by a recording module associated with the server computer.

8. The method of claim 7, wherein identifying the dynamic data is performed offline with respect to recording of the recorded data.

9. The method of claim 1, further comprising building the script, where the script is a transport script to simulate traffic behavior relating to execution of the application process.

10. An article comprising at least one machine-readable storage medium storing instructions that upon execution cause a system to:
receive recorded data of a plurality of execution instances of an application process;
analyze the recorded data to identify dynamic data associated with the plurality of execution instances of the application process, wherein the dynamic data includes correlation data for identifying a communication between at least one client computer and a server computer; and
store the dynamic data in a data structure for retrieval to build a script that is to be replayed to simulate behavior relating to execution of the application process.

11. The article of claim 10, wherein analyzing the recorded data to identify dynamic data comprises analyzing the recorded data using a selected one or combination of a plurality of dynamic data identification techniques.

12. The article of claim 10, wherein the dynamic data further includes asynchronous data generated by the server computer and provided to the at least one client computer.

13. The article of claim 10, wherein the dynamic data further includes user-entered parameter data.

14. The article of claim 10, wherein the dynamic data further includes data generated by the at least one client computer that is transformed from input data received at the at least one client computer.

15. The article of claim 10, wherein the analyzing of the recorded data is performed offline with respect to recording of the data of the plurality of execution instances of the application process.

16. A system comprising:
at least one processor to:
receive a data structure containing dynamic data of a plurality of execution instances of an application process, where the dynamic data includes correlation data for identifying a communication between at least one client computer and a server computer, and user-entered parameter data; and
query the data structure to retrieve the dynamic data of the plurality of execution instances of the application process for producing a script that simulates behavior relating to execution of the application process.

17. The system of claim 16, wherein the at least one processor is to further build the script, where the script is a transport script to simulate traffic behavior relating to execution of the application process.

18. The system of claim 16, wherein the dynamic data further includes asynchronous data generated by the server computer and provided to the at least one client computer.

19. The system of claim 16, wherein the dynamic data further includes data generated by the at least one client computer that is transformed from input data received at the at least one client computer.
